(19) United States
(12) Patent Application Publication
(10) Pub. No.: US 2010/0247981 A1
(43) Pub. Date: Sep. 30, 2010

(54) METHOD FOR ENERGY MANAGEMENT OF COMPOSITE BATTERY AND SYSTEM FOR THE SAME

(75) Inventor: Hsueh Cheng Huang, Hamilton (NZ)

Correspondence Address: EDWARDS ANGELL PALMER & DODGE LLP, P.O. BOX 55874, BOSTON, MA, 02205, US

(73) Assignee: OPEN MINDER GROUP LIMITED, Tortola (VG)

(21) Appl. No.: 12/750,288

(22) Filed: Mar. 30, 2010

(30) Foreign Application Priority Data
Mar. 31, 2009 (TW) 098110597

(51) Int. Cl. H01M 2/00

(52) U.S. Cl. 429/50; 429/61

(57) ABSTRACT

A method and system for energy management of a composite battery are provided to control and manage products of reaction going on in the composite battery. During the reaction, the gas products are usually exhausted and wasted. If the gases could be recycled, battery effectiveness would be improved. According to the present invention, the gases are collected and then recycled by an exhaust gas recycling device. In addition, the method and system involve analyzing data of the generated electrical energy, data of the produced gases, operational data of the composite battery and device data for the exhaust gas recycling device. Thus, the composite battery is controlled and managed according to the analysis, and its effects are improved.

### BACKGROUND OF THE INVENTION

1. Field of the Invention

The present invention relates to methods and systems for energy management of composite batteries, and, more particularly, to a method and system for performing energy management on a composite battery by analyzing, controlling, and managing products of the electrochemical reaction going on in a fuel cell.

2. Description of Related Art

Nowadays, energy resource management and environmental protection are both critical issues. Excess energy consumption by human beings not only causes a shortage of energy but also produces environmental pollution. For example, vehicles are still powered mostly by petroleum products, and thus the burning of fossil fuel pollutes the air and the surroundings. Therefore, it is desirable to develop vehicles powered by energy other than fossil fuels, for example, electric powered vehicles that can reduce oil consumption and environmental pollution. In order to improve the efficiency of utilization of electrical energy and to reduce pollution, alternative ways to generate electric power have been proposed. Among them is the technology of fuel cells, or fuel batteries. This is because, in spite of the generated electrical energy, the other products of the electrochemical reaction going on in the fuel cells are not harmful to human beings and the environment. This is also the reason why some portable 3C consumer products or stationary engines are powered by fuel cells.

A fuel cell is a device for converting chemical energy of its fuel into electrical energy, wherein fuel (the reactant) is consumed during conversion and must be at least periodically replenished from an external source. An electrochemical reaction, namely a reaction whereby chemical energy is converted into electrical energy, takes place inside the fuel cell under preset conditions. A fuel cell typically comprises two electrodes (cathode and anode), an electrolytic membrane with permeability, current collectors, and so on.

Chemical reactions, like oxidation of fuel and reduction of oxidants, occur at both electrodes. The electrodes not only facilitate the propagation of protons but also separate oxidants from reductants. The current collectors collect current and evacuate produced gases. During operation of a hydrogen fuel cell, hydrogen is supplied to the fuel cell through the anode, and oxygen or air is supplied to the fuel cell through the cathode. Then, hydrogen is decomposed into hydrogen protons and electrons. A current formed by the separated electrons forms so-called electric power, which provides the functionality of a fuel cell. Hydrogen protons pass through the electrolytic membrane, combine with the oxygen from the cathode and electrons returning from the connected electrical circuit, and finally generate water and heat. Although energy must still be expended to isolate fuel for fuel cells, once supplied with such fuel, a fuel cell can cleanly convert chemical energy into electrical energy on demand without undesirable pollutants, and thus fuel cells have gained worldwide attention in recent years.

The characteristics of a fuel cell depend on the fuel supplied to the fuel cell (typically, a gas of some sort) and on the metals used within the fuel cell. That is, the products of the fuel cell and its performance in generating electricity depend on the kind and volume of the input gas, and the kind of metal employed. The products of reaction going on in a conventional fuel cell, such as gases, water and heat, are usually evacuated or exhausted. They are not kept or recycled so they are useless to the fuel cell. However, fuel cells could be more practical if the exhausted products were collected, recycled, and then be kept or converted for other applications.

### SUMMARY OF THE INVENTION

In order to overcome the drawbacks of prior arts, the present invention provides a method for energy management of a composite battery. The method involves collecting gas generated by the composite battery and recycling the gas collected. The method further involves managing and controlling operation of the composite battery by means of data analysis. The method of the present invention is described as follows.

The composite battery according to the present invention refers to a fuel cell whose purpose is to generate electrical energy by a reaction going on in the composite battery, wherein the reaction also produces byproducts, such as gases. Both electrical energy and gases are concurrently generated, with the gases being collected for later use. Byproducts generated by the reaction going on in a traditional composite battery, such as gases, are ignored or not used. The produced gases are inhibited, evacuated or exhausted in the prior arts. In contrast, as disclosed in the present invention, byproduct gases to be used by an exhaust gas recycling device later are collected and kept. The operation of the exhaust gas recycling device is adjusted according to analysis of the composite battery and the recycling device itself. Only byproduct gases related to the present invention are discussed herein. The exhaust gas recycling device is a device that stores and uses byproduct gases. According to the present invention, a byproduct gas is introduced into the exhaust gas recycling device for gas conversion. For example, a byproduct gas like hydrogen is introduced into a hydrogen battery as an energy source, or it is collected by a storage device. For instance, the byproduct hydrogen is securely kept in a hydrogen storage device, or the hydrogen is burnt to generate electricity or produces power. For example, the analyzed data are examined to generate corresponding control signals. Then, the control signals are sent to the composite battery and exhaust gas recycling device so as to conduct related operations.

According to the present invention, the data of the generated electrical energy and the data of any produced gas are measured or retrieved, and operational data of the composite battery and device data of the exhaust gas recycling device are retrieved, while the composite battery is operating. The data are then analyzed, and then corresponding control and management of the composite battery or the exhaust gas recycling device are done based on the analysis.

Furthermore, the collected gases can be directly supplied to other power mechanisms. Alternatively, the gases can be collected and stored for future use. In comparison, the produced gases in conventional fuel cells are often neglected, inhibited, evacuated or exhausted. As a result, the usage of composite batteries of the present invention may attain maximum effectiveness.

The present invention further provides a system for energy management of a composite battery. The system comprises a receiving module, an analyzing module, a data storage module and a control module. The relationship and functions among these modules are explained as follows. (1) The receiving module connects the composite battery, the exhaust gas recycling device and a pleasuring device together. It receives data about the generated electrical energy and data about the produced gas during the electrochemical reaction going on inside the composite battery, and it also receives operational data of the battery and device data of the exhaust gas recycling device. (2) The analyzing module is connected to the receiving module. It analyzes the data of the generated electrical energy, the data of the produced gas, the operation data of the composite battery, and the device data provided by the exhaust gas recycling device. (3) The data storage module, which is connected to the analyzing module and receiving module, respectively, stores data before and after the analysis. Lastly, (4) the control module, which is connected to the data storage module, is used to examine the analysis to generate control signals. The control module also transfers the control signals to the composite battery and the exhaust gas recycling device in order to adjust or control them.

The present invention further provides a system for energy management of a composite battery. The system comprises a receiving module, an analyzing module, a data storage module and a responding module. The receiving module receives input data or preset data concerning the generated electrical energy, gas data, operational data of a composite battery, and device data of the exhaust gas recycling device in operation. The analyzing module analyzes the data of the generated electrical energy, the data of the produced gas, the device data, and the operational data in order to generate analysis. The data storage module stores the data of the generated electrical energy, the data of the produced gas, the device data, and the operational data and the analysis. The responding module examines the analysis and takes corresponding actions based on the examination.

The method and system of the present invention involve analyzing data of the electrical energy produced, data of the produced gas, the status of the composite battery, and operational data of the exhaust gas recycling device through a control and management mechanism, so as to enable better understanding of the operating status of the composite battery. Furthermore, adjustments are made to the composite battery and exhaust gas recycling device based on the data. In contrast with a conventional composite battery configured for no more than an electrochemical reaction, the method of the present invention renders a composite battery thereof functionally adjustable and more efficient.

### BRIEF DESCRIPTION OF DRAWINGS

FIG. 1 is a flow chart of an embodiment of a method for energy management of a composite battery according to the present invention;

FIG. 2 is a system block diagram of a framework of a system for energy management of the composite battery according to the present invention; and

FIG. 3 is a system block diagram of an embodiment of the system for energy management of the composite battery according to the present invention.

### DETAILED DESCRIPTION OF PREFERRED EMBODIMENTS

Specific embodiments are herein described to detail the present invention, and numerous advantages and effects of the present invention will become readily apparent to those skilled in the art once the disclosure of the present invention is fully appreciated. As such, the present invention may be implemented with various embodiments.

Electrical energy and byproducts, such as gases, are continuously generated by the electrochemical reaction going on inside a composite battery in operation. The present invention focuses on the manipulation of the byproduct gases. A wide variety of gases can be generated by a composite battery, depending on battery components, fuel used, constituent metals employed, and the chemical reaction involved. The gases can be handled with a method for energy management of the composite battery as disclosed in the present invention.

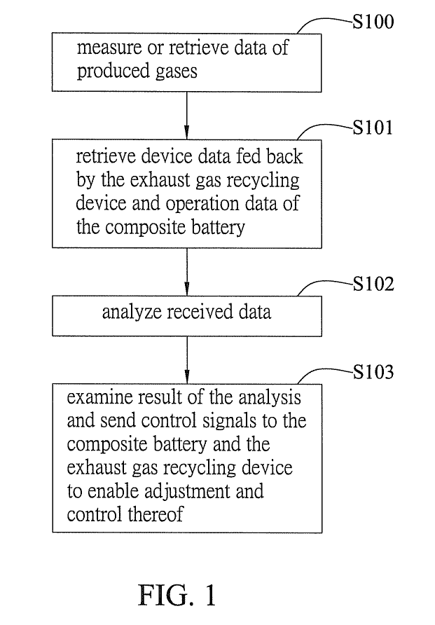

FIG. 1 is a flow chart of a method for energy management of a composite battery according to the present invention. The method comprises the following steps.

In Step S100, electrical energy generated and gases produced by the electrochemical reaction going on inside a composite battery are monitored by continuously measuring electrical current (with an ammeter), voltage (with a voltmeter), impedance (with an impedance meter), the electrical output waveform (with a signal measuring device), the flow rate and production rate of the gases (with a gas flow meter), and the temperature of the gases (with a thermometer). The above data are parameters related to the operation of the composite battery. Continuous measurement of the parameters, such as production of electrical current and gases or the quantity of fuel available for use inside the composite battery, helps to better understand the operational status of the composite battery.

In Step S101, the method of the present invention involves collecting and recycling the gases continuously generated by the composite battery. The gases thus generated are introduced into an exhaust gas recycling device, and the device data fed back by the recycling device are retrieved. The exhaust gas recycling device may include various appliances, like power units or storage devices. Different appliances display different characteristics. For example, a power unit may feed back data like rotor speed, power, wattage or combustion efficiency, and a storage device may feed back data like the accumulation rate or accumulation weight. During this step, the preset production of electrical energy/gases according to existing battery or chemical calculations may also be retrieved.

The status of the composite battery varies while electrochemical reaction is going on inside. The performance of the composite battery in operation is subject to the conditions of the ambient environment, such as the ambient temperature, temperature of battery, flow rate of fuel, pressure at the electrodes, concentration of electrolytes, and so on. Generally speaking, a composite battery operates with optimal performance by using default settings. As time passes, performance of the composite battery deteriorates as a result of the electrochemical reaction going on therein, which can degrade electrodes and so on. The understanding of the operating status of a composite battery is conducive to controlling or improving the pattern of operation of the composite battery. Step S101 further involves retrieving the operational data fed back by the composite battery for subsequent analysis.

In Step S102, the received and retrieved data are analyzed in order to understand the electrochemical reaction going on inside the composite battery and the operating status of an attached exhaust gas recycling device. Data of the generated electrical energy, data of the produced gas, operational data of the composite battery, and device data of the exhaust gas recycling device are stored and recorded to facilitate subsequent analysis.

In Step S103, the analytic data obtained in Step S102 is examined, in order to generate corresponding control signals to send to the composite battery or the exhaust gas recycling device for adjusting operation of the composite battery or operation of the exhaust gas recycling device. For example, if the exhaust gas recycling device operates at excessive speed or power, the flow of the produced gas may be adjusted. In another situation, the gas storage tank may be full, in which case the switching of pipes is required. The process and method of adjustment may vary, depending on the type of exhaust gas recycling device employed.

In a preferred embodiment, a simulation of the electrochemical reaction occurring in a composite battery is conducted, wherein the method of the present invention involves tracking the data obtained from the simulated generation of electrical energy and the data obtained from the simulated production of gas, and/or retrieving simulated device data fed back by the exhaust gas recycling device and simulated operational data fed back by the composite battery, so as to conduct subsequent analysis of the data obtained by simulation, take corresponding actions, or make adjustments to the actual composite battery and the attached exhaust gas recycling device.

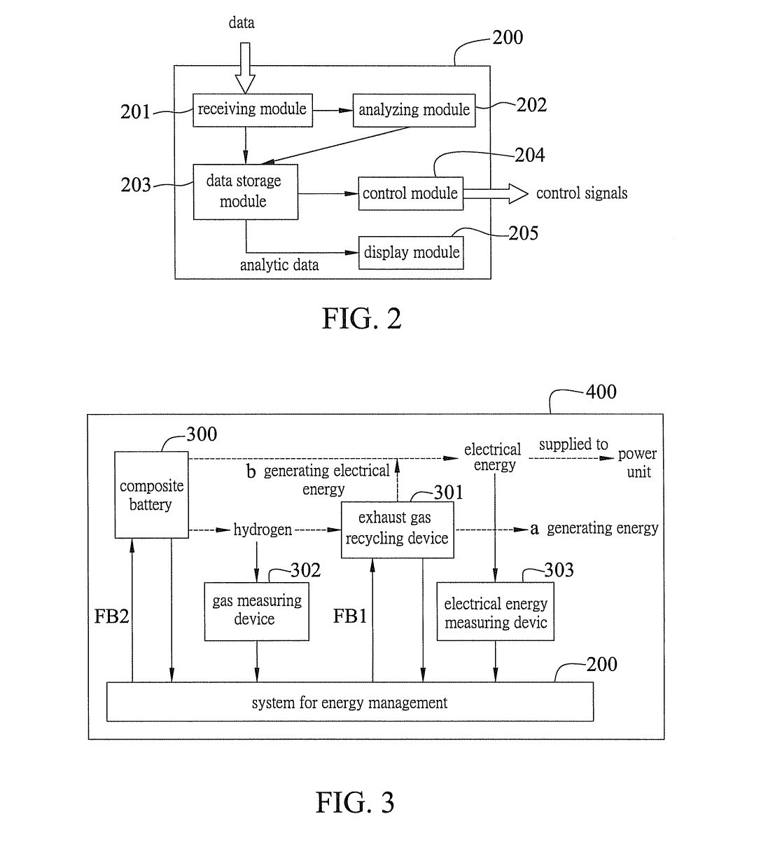

Referring to FIG. 2, a system block diagram of a framework of a system 200 for energy management of a composite battery according to the present invention is shown. Components of the system 200 of the present invention are detailed as follows.

The system 200 of the present invention comprises a receiving module 201, an analyzing module 202, a data storage module 203 and a control module 204. The receiving module 201 receives data that are fed back, like data tracking the generated electrical energy (current/voltage/time), data of the produced gas, operational data of the composite battery, and device data of an exhaust gas recycling device employed. The analyzing module 202 is connected to the receiving module 201 and configured to analyze the aforesaid tracked data. The status of the composite battery and performance of the exhaust gas recycling device can be better understood by analyzing the data such that the composite battery and exhaust gas recycling device can be adjusted optimally. The data storage module 203 is connected to the receiving module 201 and the analyzing module 202 and configured to store various data and analytic data. Moreover, the control module 204 is connected to the data storage module 203 and configured to examine the analytic data so as to generate corresponding control signals. The control signals are sent to the composite battery and the exhaust gas recycling device, so as to adjust or control the composite battery and the exhaust gas recycling device.

In a preferred embodiment, the system of the present invention further comprises a display module 205 for displaying analytic data or related data so that users can readily understand the operating status of the composite battery and the exhaust gas recycling device.

In another preferred embodiment, a measuring device sends the data of the simulated generation of electrical energy and data of simulated production of gas to the receiving module. Alternatively, the composite battery and the exhaust gas recycling device send simulated operational data and simulated device data, respectively, to the receiving module, so that the analyzing module can conduct analysis of the simulated conditions and further control or adjust the composite battery and the exhaust gas recycling device.

The present invention further provides a system for energy management of the composite battery. The system comprises a receiving module, an analyzing module, a data storage module and a responding module. The receiving module receives input data or preset data of the generated electrical energy, data of gas production, operational data of a composite battery, and device data of an exhaust gas recycling device in operation. The analyzing module analyzes the data of the generated electrical energy, the data of the produced gas, the device data, and the operational data in order to create analytic data. The data storage module stores the data of the generated electrical energy, the data of the produced gas, the device data, the operational data, and the analytic data. The responding module examines the analytic data and takes actions according to the results of the examination of the analytic data.

In practice, users can perform various analysis and calculations on the simulated data in order to get a better understanding of various control strategies and adjustments for the composite battery and the exhaust gas recycling device.

In a preferred embodiment, the responding module outputs information related to energy management according to the results of the examination. The responding module outputs information related to energy management including, for example, system simulation information, system status information, system analysis information, or recommended control information, to be watched by users, so that the users can understand the operating status of the system to the fullest. Moreover, the composite battery or the exhaust gas recycling device is adjusted, controlled, or managed by the responding module according to the results of the examination.

In another preferred embodiment, the aforementioned receiving module, analyzing module, data storage module and responding module can be implemented in the form of computer software.

According to the system 200 of the present invention, the receiving module 201, the analyzing module 202, the data storage module 203 and the control module 204 can be implemented in the form of computer software. The software can be stored in a storage media device. Alternatively, the modules related to the system 200 can also be implemented in the form of electronic circuits to provide the same technical solution.

A specific embodiment of the present invention is described in detail as follows.

Owing to wide use of fuel cells, the present invention provides a method and system for energy management of a composite battery so as to recycle gases generated by electrochemical reaction going on in the composite battery and thereby improve battery performance. In the following embodiment, a vehicle is equipped with the composite battery according to the present invention.

Referring to FIG. 3, which is a system block diagram showing the status of a vehicle 400 equipped with the composite battery of the present invention, solid arrows indicate data flow, and dotted arrows indicate energy flow.

The vehicle 400 is powered by electrical energy supplied by the composite battery 300. The composite battery 300 in operation generates electrical energy and gases (described to the extent required for illustration of the present invention). In prior arts, the gases thus generated are inhibited, evacuated or exhausted. By contrast, the present invention provides an exhaust gas recycling device 301 for recycling and reusing the gases generated.

The system 200, whose internal structure is illustrated in FIG. 2, is connected to the aforementioned exhaust gas recycling device 301. The system 200 receives device data from the exhaust gas recycling device 301 while reusing the produced gases, gas flow data measured by the gas measuring device 302 (in this case, the composite battery 300 generates hydrogen), electrical energy data measured by the electrical energy measuring device 303, and operational data fed back by the composite battery 300. All the data is sent back to the system 200 and then analyzed by the analyzing module 202 inside the system 200 (as shown in FIG. 2). Then, the analyzing module 202 creates analytic data. Afterwards, all the data and the analytic data are stored in the data storage module 203 inside the system 200 (as shown in FIG. 2).

Finally, the control module 204 of the system 200 examines the analytic data so as to generate corresponding control signals. Then, the control module 204 provides feedback by sending the control signals to the composite battery 300 (as indicated by the notation “FB2” shown in the drawing) so as to control, manage or adjust operation of the composite battery 300. For instance, the performance of the composite battery 300 is optimized by controlling or adjusting water, a reagent, or the flow of gas supplied to the composite battery 300. Furthermore, the control module 204 gives feedback by sending the control signals back to the exhaust gas recycling device 301 (as indicated by the notation “FB1” shown in the drawing) as a kind of reference thereby to generate gas, control operations or switch devices.

In a preferred embodiment, the system 200 further comprises a display module for displaying various data received by the system 200, so that users can readily understand the operating status of the composite battery 300 and the exhaust gas recycling device 301.

The aforementioned exhaust gas recycling device 301 can collect and recycle the gases generated by the composite battery 300. The exhaust gas recycling device 301 includes an internal combustion engine, a combustion machine, a compressor, a generator, a gas synthesizer/producer, a hydrogen battery or other utilization/production/actuation devices that exploit hydrogen, or a storage device which stores the produced gases (hydrogen in this case). For example, where the exhaust gas recycling device 301 is an internal combustion engine, the hydrogen generated by the composite battery 300 can be fuel supplied to the internal combustion engine for generating energy (as indicated by dashed arrow ‘a’ shown in FIG. 3). Where the exhaust gas recycling device 301 is a hydrogen cell, the hydrogen generated by the composite battery 300 can be fuel supplied to the hydrogen cell for generating electrical energy (as indicated by dashed arrow ‘b’ shown in FIG. 3). Alternatively, the generated hydrogen can also be applied to a combustion machine. The gas recycling methods mentioned above can improve the performance of fuel cells. Moreover, if the produced gas is not needed by other components inside the vehicle 400, the exhaust gas recycling device 301 can include one or more storage devices for storing the generated hydrogen such that the stored hydrogen can be resold or utilized later, which provides added operational value for the composite battery 300.

In conclusion, the method and system for energy management of a composite battery according to the present invention have the following effects:

(1) The method and system entail collecting data related to electrical energy generated by an electrochemical reaction going on in the composite battery, data of produced gas, operational data fed back by the composite battery, and data related to an exhaust gas recycling device in operation. Then, all the data is analyzed in order for corresponding control signals to be generated. The control signals are further used to adjust, control or manage various operations of the composite battery or the exhaust gas recycling device so as to improve the performance thereof.

(2) The produced gas is converted by the exhaust gas recycling device into a fuel source for other gas actuation devices or stored for future use. In short, the produced gas from the composite battery is recycled and converted into utilizable energy, thus provide significant added operational value for the composite battery.

The foregoing descriptions of the detailed embodiments are illustrated to disclose the principles and functions of the present invention and are not restrictive of the scope of the present invention. It should be understood by those skilled in the art that various modifications and variations made in the present invention according to the spirit and principles of the present invention fall with the scope of the claims of the present invention.

What is claimed is:

1. A method for energy management of a composite battery, applicable to control and management of gas and electrical energy generated by a chemical reaction going on inside the composite battery, wherein the composite battery is coupled to at least an exhaust gas recycling device used to reuse the produced gas, the method comprising the steps of:
(1) measuring or retrieving electrical energy data and gas data generated by the chemical reaction going on inside the composite battery;
(2) retrieving device data fed back by the exhaust gas recycling device and operational data fed back by the composite battery; and
(3) creating analytic data by analyzing the electrical energy data, the gas data, the device data, and the operational data, so as to correspondingly control and manage the composite battery or the exhaust gas recycling device according to the analytic data.

2. The method of claim 1, wherein Step (1) further comprises computing electrical energy data and gas date generated by a simulation of the chemical reaction going on inside the composite battery.

3. The method of claim 1, wherein Step (2) further comprises retrieving simulated device data fed back by the exhaust gas recycling device, and simulated operational data fed back by the composite battery.

4. The method of claim 1, wherein the gas generated by the chemical reaction includes hydrogen, organic gases, or steam.

5. The method of claim 1, wherein the exhaust gas recycling device includes an internal combustion engine, a fuel cell, a combustion machine, a compressor, or a storage device, the device data fed back by the gas recycling device in operation includes throughput, diffusion rate, accumulation rate, power or energy, and the operational data of the composite battery comprise the composite battery's weight, temperature, voltage, current, or flow rate of gas.

6. The method of claim 1, wherein Step (3) further comprises adjusting water, a reagent, or flow of gas supplied to the composite battery according to the analytic data, so as to optimize performance of the composite battery.

7. The method of claim 1, wherein Step (3) further comprises generating gas, controlling operation or switching by the exhaust gas recycling device according to the analytic data.

8. A system for energy management of a composite battery, applicable to control and management of gas produced and electrical energy generated by a chemical reaction going on inside the composite battery, wherein the system is connected to the composite battery, a measuring device, and at least an exhaust gas recycling device, the system comprising:
a receiving module for receiving electrical energy data and produced gas measured by the measuring device, operational data of the composite battery, and device data of the exhaust gas recycling device in operation;
an analyzing module for analyzing the electrical energy data, the produced gas data, the device data, and the operational data in order to create analytic data;
a data storage module for storing the electrical energy data, the produced gas data, the operational data, the device data, and the analytic data; and
a control module for examining the analytic data to generate control signals, so as to correspondingly control and manage the composite battery or the exhaust gas recycling device according to the generated control signals.

9. The system of claim 8, wherein the measuring device sends simulated electrical energy data and simulated gas data to the receiving module, so as to allow the analyzing module to create simulated conditions by analyzing the simulated electrical energy data and the simulated gas data.

10. The system of claim 8, wherein the composite battery and the gas recycling device send simulated operational data and simulated device data to the receiving module, respectively, so as to allow the analyzing module to create simulated conditions by analyzing the simulated operational data and simulated device data.

11. The system of claim 8, wherein the produced gas includes hydrogen, organic gases, or steam.

12. The system of claim 8, wherein the exhaust gas recycling device includes an internal combustion engine, a fuel cell, a combustion machine, a generator, a gas synthesizer/producer, a compressor, or a storage device, the device data fed back by the exhaust gas recycling device in operation includes throughput, diffusion rate, accumulation rate, power or energy, and the operational data of the composite battery includes weight, temperature, voltage, current, or gas flow.

13. The system of claim 8, wherein the control module adjusts water, a reagent, or flow of gas supplied to the composite battery according to the received analysis, so as to optimize performance of the composite battery.

14. The system of claim 8, wherein the control module controls the exhaust gas recycling device in generating gas, controlling operations or switching according to the analytic data received.

15. The system of claim 8, wherein the data storage module is connected to a display module for displaying the analytic data for users to watch.

16. The system of claim 8, wherein the measuring device is a gas flow meter for measuring gas flow, an ammeter for measuring the electrical current, a voltmeter for measuring voltage, an impedance meter for measuring impedance, a signal measuring device for measuring the electrical output waveform, or a thermometer.

17. The system of claim 8, wherein the receiving module, the analyzing module, the data storage module and the control module are implemented in the form of electronic circuit structures or in the form of computer software which is stored in storage media.

18. A system for energy management of a composite battery, comprising:
a receiving module for receiving input data or preset data of the generated electrical energy, data of produced gas, operational data of a composite battery, and device data of an exhaust gas recycling device in operation;
an analyzing module for analyzing the data of the generated electrical energy, the data of the produced gas, the device data, and the operational data so as to create analytic data;
a data storage module for storing the data of the generated electrical energy, the data of the produced gas, the operational data, the device data, and the analytic data; and
a responding module for examining the analytic data and taking corresponding actions based on the examination.

19. The system of claim 18, wherein the responding module outputs information pertaining to energy management according to the results of the examination, and the composite battery or the exhaust gas recycling device is adjusted, controlled, or managed by the responding module according to the results of the examination.

20. The system of claim 18, wherein the receiving module, the analyzing module, the data storage module and the responding module are implemented in the form of computer software.
